(19) United States
(12) Patent Application Publication
(10) Pub. No.: US 2010/0014057 A1
(43) Pub. Date: Jan. 21, 2010

(54) COLOR WHEEL AND PROJECTOR USING SAME

(75) Inventors: PO-WEN CHAN, Tu-Cheng (TW); YU-LUN HO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/340,646

(22) Filed: Dec. 20, 2008

(30) Foreign Application Priority Data
Jul. 17, 2008 (CN) 200810302778.2

(51) Int. Cl. G03B 21/14

(52) U.S. Cl. 353/84

(57) ABSTRACT

A color wheel for use in a projector includes a motor having a rotor, a carrier fixed to the rotor, and a color filter attached to the carrier. The color filter includes a substrate, a plurality of first film groups and a second film group formed on the substrate. Each first film group includes a high refraction index film and a low refraction index film that are stacked. The second film group includes a trititanium pentoxide film and a low refraction index film. The second film group is formed in the color filter with a position selected from a plurality of predetermined positions using a thin film design software.

### BACKGROUND

1. Technical Field

The present disclosure relates to color wheels and, particularly, to color filter adhesively attached to a color wheel and a projector using the same.

2. Description of the Related Art

Color wheels are commonly used as a sequential dispersing device in digital light processing (DLP) projectors to separate white light into red (R), green (G) and blue (B) light, and in cooperation with a digital micro-mirror device (DMD) to project a color image. Such a color wheel typically includes a motor having a rotor, a carrier fixed to the rotor, a disk-shaped color filter that commonly includes a plurality of fan-shaped filter segments adhered to each other and attached on the carrier by a layer of adhesive, and a cover attached to the color filter by another layer of adhesive. The motor drives the color filter to rotate at high speed. The cover is configured for blocking light, particularly ultraviolet radiation from directly impinging on the adhesive. However, the diameter of the cover is usually significantly smaller than that of the color filter to leave a light transmissive region on the color filter for filtering light. As a consequence, a small amount of light can still reach the adhesive via reflections in the color filter, thereby deteriorating the adhesive. As a result, the color filter may easily fall from the carrier, particularly during high-speed rotation of the color filter.

Therefore, what is needed is a color wheel and a projector using the same which can overcome the above problem.

### BRIEF DESCRIPTION OF THE DRAWINGS

FIG. 1 is a schematic, planer view of a projector according to an exemplary embodiment.

FIG. 2 is an enlarged, cross-sectional view of a color filter of the projector of FIG. 1.

FIG. 3 is a graph showing a relationship between the transmittance of light and wavelength of light passing through the color filter of the projector of FIG. 2.

### DETAILED DESCRIPTION

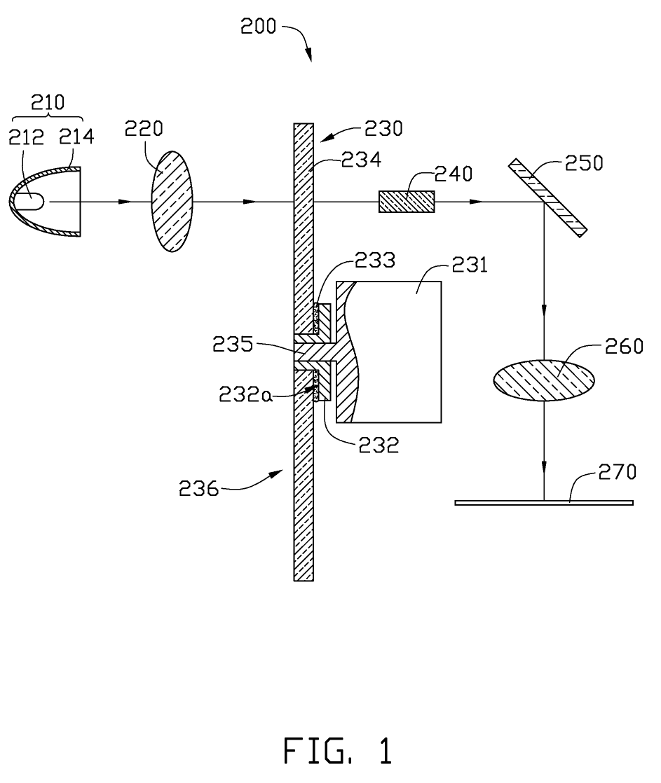

Referring to FIG. 1, a projector 200 such as a digital light processing (DLP) projector according to an exemplary embodiment includes a light source 210, a condensing lens 220, a color wheel 230, an integration rod 240, a digital micro-mirror device (DMD) 250 and a projection lens 260.

The light source 210 includes a lamp 212 and a lamp reflector 214. The lamp 212, such as a high pressure mercury lamp, a metal halide lamp, or a xenon lamp, is configured for generating white light beams. The lamp reflector 214 reflects the light beams generated by the lamp 212 to the condensing lens 220.

The condensing lens 220 is positioned between the light source 210 and the color wheel 230. The condensing lens 220 is configured for condensing the white light beams from the light source 210.

The color wheel 230 is positioned in a light path of the light beams from the light source 210 for receiving the condensed white light beams and is configured for dispersing the condensed white light beams impinging thereon into three colored lights, such as red (R), green (G), and blue (B) lights. The color wheel 230 includes a motor 231, a carrier 232, a layer of adhesive 233, and a color filter 234 that commonly includes a plurality of fan-shaped filter segments (not shown).

The motor 231 includes a rotor 235 and is configured for driving the color filter 234 to rotate at high speed. In this embodiment, the rotor 235 is a rotating housing with a shaft coaxially protruding therefrom. In addition to the rotor 235, the motor 231 further includes an electromagnetic member (not shown), e.g., ferromagnets on the inner surface of the rotating housing and windings fixedly received within the rotating housing for driving the rotor 235 to rotate when the windings are electrically powered.

The carrier 232 is sleeved around the rotor 235 via the adhesive 233 or thread. Specifically, the carrier 232 is a metal ring and has an attachable surface 232a away from the motor 231.

In this embodiment, the adhesive 233 is a heat-curable adhesive, such as a UV curable adhesive.

The color filter 234 includes three fan-shaped filter segments adhered to each other, such as R, G, and B color filter segments. The color filter segments are annularly arranged and attached to the attachable surface 232a of the carrier 232 via the adhesive 233 to form an annular transmissive region 236 being inserted in the light path of the condensed white light beams. When the rotor 235 rotates, the annular transmissive region 236 is driven to rotate and separates the condensed white light into color lights, e.g., R, G, and B lights.

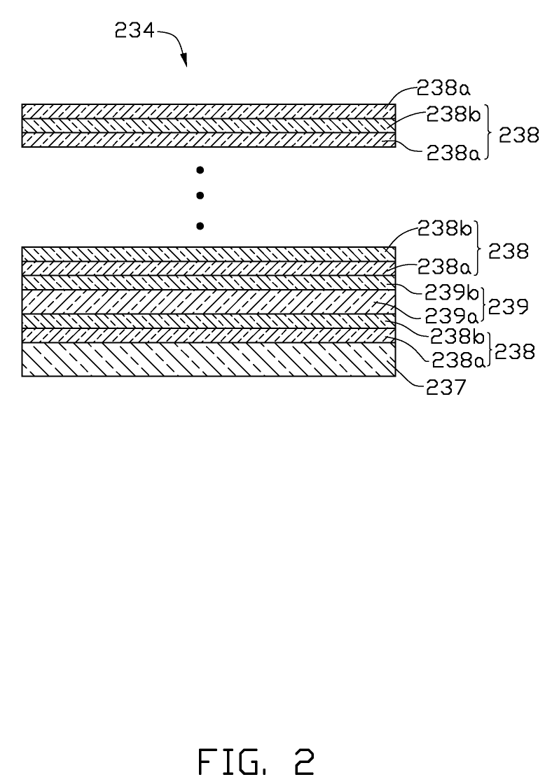

Referring to FIG. 2, the color filter 234 includes a substrate 237, a plurality of first film groups 238, and a second film group 239. Each first film group 238 includes a high refraction index film 238a and a low refraction index film 238b that are stacked. In this embodiment, the high refraction index film 238a is Ta₂O₅ (tantalum pentoxide) film and the low refraction index film 238b is SiO₂ (silicon dioxide) film. The second film group 239 includes a Ti₃O₅ (trititanium pentoxide) film 239a and a low refraction index film 239b. In this embodiment, the physical thickness of the Ti₃O₅ film 239a is 612 nanometers (nm), and the lower refraction index film 239b is SiO₂ film.

In this embodiment, the color filter 234 includes twenty-two first film groups 238, a second film group 239 and a single high refraction index film 238a. The second film group 239 is formed on the first film group 238 closest to the substrate 237 with the Ti₃O₅ film 239a stacked on the low refraction index film 238b. The single high refraction index film 238a is outmost of the first film groups 238 away from the substrate 237. The layer number, the material of each layer and the physical thickness of each layer are shown in Table 1 below. The bigger the layer number of the layer is, the further the layer is away from the substrate 237.

TABLE 1

| Layer NO. | Material | Thickness (nm) |
|---|---|---|
| 1 | Ta₂O₅ | 24.06 |
| 2 | SiO₂ | 48.41 |
| 3 | Ti₃O₅ | 612 |
| 4 | SiO₂ | 57.1 |
| 5 | Ta₂O₅ | 49.13 |
| 6 | SiO₂ | 82.07 |
| 7 | Ta₂O₅ | 48.93 |
| 8 | SiO₂ | 84.33 |
| 9 | Ta₂O₅ | 37.03 |
| 10 | SiO₂ | 68.29 |
| 11 | Ta₂O₅ | 35.3 |
| 12 | SiO₂ | 87.77 |
| 13 | Ta₂O₅ | 39.67 |
| 14 | SiO₂ | 88.53 |
| 15 | Ta₂O₅ | 39.43 |
| 16 | SiO₂ | 87.26 |
| 17 | Ta₂O₅ | 45.13 |
| 18 | SiO₂ | 73.75 |
| 19 | Ta₂O₅ | 39.54 |
| 20 | SiO₂ | 101.1 |
| 21 | Ta₂O₅ | 57 |
| 22 | SiO₂ | 78.17 |
| 23 | Ta₂O₅ | 51.82 |
| 24 | SiO₂ | 78.02 |
| 25 | Ta₂O₅ | 88.2 |
| 26 | SiO₂ | 62.97 |
| 27 | Ta₂O₅ | 67.5 |
| 28 | SiO₂ | 74.4 |
| 29 | Ta₂O₅ | 66.91 |
| 30 | SiO₂ | 75.88 |
| 21 | Ta₂O₅ | 70.71 |
| 32 | SiO₂ | 80.15 |
| 33 | Ta₂O₅ | 65.44 |
| 34 | SiO₂ | 78.18 |
| 35 | Ta₂O₅ | 64.75 |
| 36 | SiO₂ | 79.88 |
| 37 | Ta₂O₅ | 62.4 |
| 38 | SiO₂ | 88.65 |
| 39 | Ta₂O₅ | 63.53 |
| 40 | SiO₂ | 77.59 |
| 41 | Ta₂O₅ | 54.53 |
| 42 | SiO₂ | 105.44 |
| 43 | Ta₂O₅ | 42.2 |
| 44 | SiO₂ | 68.02 |
| 45 | Ta₂O₅ | 110.12 |
| 46 | SiO₂ | 76.47 |
| 47 | Ta₂O₅ | 15.22 |
| — | — | — |

A vacuum coating method or a sputtering method may be used to deposit the first film groups 238 and the second film group 239 on the substrate 237. The position of the second film group 239 between the first film groups 238 is determined according simulation results using a thin film design software, such as TFCalc™ film design software sold by Software Spectra, Inc. or Macleod™ film design software sold by Thin Film Center Inc before depositing the films on the substrate 237.

A four-steps operation is required to complete the simulation using a film design software sold under the trademark TFCalc™ or Macleod™. In the simulation, first, a plurality of the first film groups 238 are directly deposited on the substrate 237. Second, a first spectrum of the light passing through the color filter 234 excluding the second film group 239 is shown by the film design software. Third, the second film group 239 is formed between two of the first film groups 238 with a position randomly selected from a plurality of predetermined positions. A second spectrum of the light passing through the color filter 234 including the second film group 239 is shown by the film design software. Fourth, the position of the second film group 239 is optimized by the film design software until the second spectrum of the light passing through the color filter 234 including the second film group 239 is similar to the first spectrum of the light passing through the color filter 234 excluding the second film group 239. Alternatively, the second film group 239 may be formed at outmost side of the plurality of the first film groups 238 as long as the second spectrum is similar to the first spectrum.

In the other embodiments, the physical thickness of the Ti₃O₅ film 239a may be changed according to the wavelength of light passing through the color filter 234 as long as the second spectrum is similar to the first spectrum.

When assembling the color wheel 230, the color filter 234 is firstly formed by depositing the plurality of the first film groups 238 and the second film group 239 on the substrate 237. The adhesive 233 is spread over the attachable surface 232a of the carrier 232. The color filter 234 is attached to the adhesive 233. The adhesive 233 is cured to fixedly connect the color filter 234 to the carrier 232. The carrier 232 together with the color filter 234 is fixed to the rotor 235.

The integration rod 240 is configured for receiving the primary color light beams from the color wheel 230 and configured for rendering the light beams uniform. The DMD 250 is configured for modulating the light beams from the integration rod 240 into visual images according to input video signals. The projection lens 260 is configured for enlarging the visual images and presenting them on a screen 270.

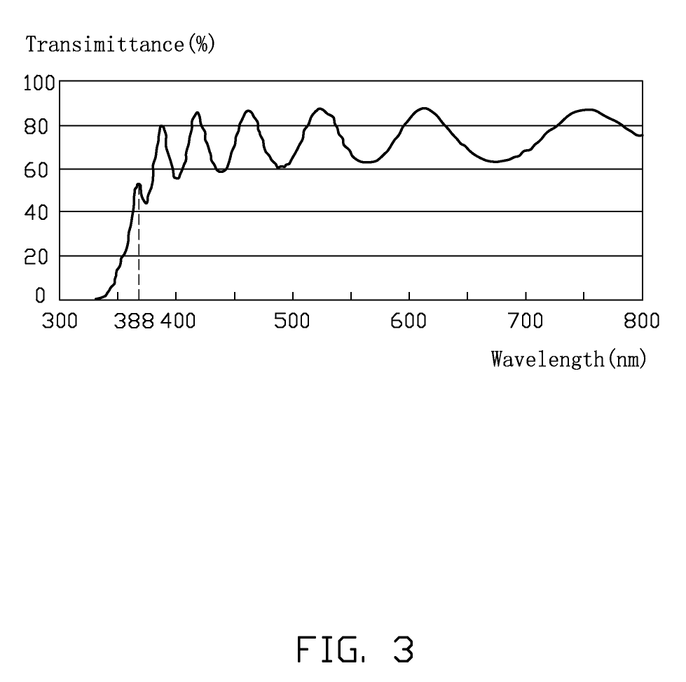

Referring to FIG. 3, a graph illustrating a relationship between the transmittance of light and wavelength of light passing through the color filter 234 is shown. The UV light having a wavelength below 388 nm is obviously absorbed. Therefore, the transmittance rate of UV light passing through the color filter 234 to deteriorate the adhesive 233 is significantly reduced, and the color filter 234 can be fixed to the carrier 232 firmly and permanently, even during a high-speed rotation of the color filter 234.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A color wheel for use in a projector, comprising:
a motor comprising a rotor;
a carrier fixed to the rotor; and
a color filter adhesively attached to the carrier;
wherein the color filter comprises a substrate, a plurality of first film groups and a second film group formed on the substrate; each first film group comprises a high refraction index film and a low refraction index film that are stacked; the second film group comprises a trititanium pentoxide film and a low refraction index film, the second film group is formed in the color filter with a position selected from a plurality of predetermined positions using a thin film design software.

2. The color wheel as claimed in claim 1, wherein the high refraction index film is tantalum pentoxide film, the low refraction index film is silicon dioxide film.

3. The color wheel as claimed in claim 1, wherein the physical thickness of the trititanium pentoxide film is about 612 nanometers (nm).

4. The color wheel as claimed in claim 1, wherein the second film group is between two of the plurality of the first film groups.

5. The color wheel as claimed in claim 1, wherein the second film group is at outmost side of the plurality of the first film groups.

6. The color wheel as claimed in claim 1, wherein the color filter comprises twenty-two first film groups, a second film group and a single high refraction index film, the second film group is formed on the first film group closet to the substrate with the trititanium pentoxide film stacked on the low refraction index film, the single high refraction index film is outmost of the first film groups away from the substrate.

7. A projector comprising:
a light source for generating white light;
a condensing lens for condensing the generated white light;
a color wheel comprising:
a motor comprising a rotor;
a carrier fixed to the rotor; and
a color filter adhesively attached to the carrier;
wherein the color filter comprises a substrate, a plurality of first film groups and a second film group formed on the substrate, each first film group comprising a high refraction index film and a low refraction index film that are stacked, the second film group comprising a trititanium pentoxide film and a low refraction index film, the second film group is formed in the color filter with a position selected from a plurality of predetermined positions using a thin film design software.
an integration rod configured for receiving the primary color light beams from the color filter and rendering the light beams uniform;
a digital micro-mirror device configured for modulating the separated color lights into visual images; and
a projection lens configured for enlarging the visual images and presenting the enlarged visual images on a screen.

8. The projector as claimed in claim 7, wherein the high refraction index film is tantalum pentoxide film, the low refraction index film is silicon dioxide film.

9. The projector as claimed in claim 7, wherein the physical thickness of the trititanium pentoxide film is about 612 nanometers.

10. The projector as claimed in claim 7, wherein the second film group is between two of the plurality of the first film groups.

11. The projector as claimed in claim 7, wherein the second film group is at outmost side of the plurality of the first film groups.

12. The projector as claimed in claim 7, wherein the color filter comprises twenty-two first film groups, a second film group and a single high refraction index film, the second film group is formed on the first film group closet to the substrate with the trititanium pentoxide film stacked on the low refraction index film, the single high refraction index film is outmost of the first film groups away from the substrate.
